(19) United States
(12) Patent Application Publication
(10) Pub. No.: US 2013/0065147 A1
(43) Pub. Date: Mar. 14, 2013

(54) Method for Controlling the Energy Management in a Fuel Cell System

(71) Applicant: Rainer Autenrieth, Heroldstatt (DE)

(72) Inventor: Rainer Autenrieth, Heroldstatt (DE)

(73) Assignee: DAIMLER AG, STUTTGART (DE)

(21) Appl. No.: 13/695,354

(22) PCT Filed: Mar. 30, 2011
(86) PCT No.: PCT/EP11/01582

§ 371 Date: Nov. 26, 2012

(30) Foreign Application Priority Data
Apr. 30, 2010 (DE) 10 2010 018 907.3

(51) Int. Cl. H01M 8/04

(52) U.S. Cl. 429/429

(57) ABSTRACT

A method for operating a fuel cell system for supplying at least one electrical consumer with electric energy is provided. The fuel cell system includes a fuel cell and an accessory for supplying the fuel cell. The efficiency of the fuel cell system is determined and the fuel cell is switched off temporarily when the efficiency of the fuel cell system falls below a switch-limit efficiency.

### BACKGROUND AND SUMMARY OF THE INVENTION

Exemplary embodiments of the present invention relate to a method for operating a fuel cell system for supplying at least one electrical consumer with electrical energy and the use of such a method in a motor vehicle.

Fuel cells have already been known for a long time and have gained considerable importance in the automobile industry sector during recent years.

Fuel cells generate electric energy on a chemical basis, whereby the operating principle of fuel cells involves the electrochemical reaction of molecules and ions with one another and to generate a flow of electrons. The generated flow of electrons can then be conducted as current through a consumer.

A fuel cell is thus an energy converter. The energy to generate electricity is made available to the fuel cell by supplying fuels, such as for example hydrogen and converted into electricity by a chemical reaction of the fuel with an oxidizing agent.

For the fuel cell to function it is necessary that the individual source materials (educts) are continuously fed to the reaction process and the reaction product is continuously removed. These and similar functions, as for example the air supply to the cathodes and anodes, are ensured by so-called accessories, which include for example pumps, compressors, vacuum pumps, valves and control units. The fuel cell and the accessory used to supply it are designated as fuel cell system.

The accessories are often likewise electrical consumers. If the performance of a fuel cell decreases the consumption of the accessories reduces to a lesser extent than the energy generated by the fuel cell. In the case of low system loads the system-efficiency of a fuel cell system falls in comparison to the fuel cell-efficiency. This leads to increased fuel consumption or in a motor vehicle to increased petrol consumption, since the deficient energy must be made available for example by a generator, such as the alternator of the motor vehicle.

Various approaches to counter this problem are known in the prior art. German Patent DE 102 61 418 A1 describes connecting a fuel cell to battery and consumer, and achieving improved efficiency of the system by enabling (switching on) and disabling (switching off) the fuel cell and the battery from the rest of the system. German Patent DE 102 02 611 C1 describes a method that controls how and in what order the components of a fuel cell system are connected. No statements are made regarding the system conditions under which this occurs. German Patent DE 100 56 429 A1 likewise discloses switching the fuel cell on and off. Here switching on and switching off take place depending on the available supply media—the efficiency achieved by the fuel cell system plays no role. Likewise the approach of switching off the fuel cell, if a pre-defined operating load is not reached, is to be regarded as known. This approach is based on the consideration that with a low operating load the system efficiency is at such a minimum level that it is expedient to disconnect the fuel cell.

These known solutions, however, possess various disadvantages. It is particularly problematic to disconnect the fuel cell at a statically selected switch-off point. Thus, if the accessories, due to operating conditions such as generator fluctuations or environmental conditions, require more energy than the fuel cell generates this is eventually not switched off.

US 2003/194586 A1 and US 2002/162694 A1 in each case describe generic fuel cell systems. EP 2 001 070 A1 can be mentioned as further prior art in respect to this topic.

Exemplary embodiments of the present invention provide a method for operating a fuel cell system so that the real operating conditions of a fuel cell are better accounted for.

A first concept of the invention involves determining the efficiency of a fuel cell system and switching off the fuel cell below a certain switch-off limit efficiency. In a preferred variation the operating load temporarily existing at the switch-off time point as well as various different system states, such as for example temperature and pressure, are stored simultaneously. The fuel cell is again advantageously switched on if the operating load exceeds a switch-on maximum load factor under consideration of the prevailing system states. “Temporary” in the sense of the invention present should be understood to be temporary disconnection of the fuel cell. This means that the fuel cell is switched off, while the fuel cell system itself continues to operate or at least is kept in a state, wherein this can be very quickly changed back again into operation. The present invention therefore does not relate to the final disconnection of the fuel cell system, but to switching the fuel cell system into a “stand-by” state.

To determine the efficiency of the fuel cell system, the energy supplied to the fuel cell can be advantageously compared to the energy supplied by the fuel cell system as available power. While the supplied energy is known, the energy provided as available power can either be measured directly or calculated by determining the energy consumption of the accessories and deducting this from the energy supplied to the fuel cell. Advantageously the fuel cell is electrically switched off, that is to say by separating the cell from the network. However, it is equally possible to switch off the fuel cell in another way, for example by stopping the fuel supply and by terminating the chemical reaction.

In this case the fuel cell system comprises a recirculation of anode exhaust gases around an anode of the fuel cell using an anode recirculating pump system, whereby when the fuel cell is switched off, the flow rate circulated by the anode recirculating pump system is maintained or reduced. Since the supply of the fuel cell with hydrogen or a comparable gas suitable for generating electricity in the fuel cell is typically relatively complex, it makes little sense when temporarily switching off the fuel cell to completely switch off an anode recirculating pump system. It is possible to only switch off the supply of hydrogen. If the gas in the recirculating pump system continues to be circulated, typically at a reduced flow rate, the fuel cell can be re-started much more quickly and efficiently, as soon as the switch-on operating load factor is reached, since at least a minimum quantity of hydrogen is present within the total region of the anode and can be converted into electricity immediately with the air then again supplied on the cathode side.

Advantageously the fuel cell is again switched on if a switch-on operating load factor is exceeded. To this end, for example, the operating load factor, at which the fuel cell was switched off, can be stored. However, the switch-on operating load factor can be static.

In a further preferred embodiment the switch-off limit efficiency and/or the switch-on operating load factor change as a function of system states. The energy of a fuel cell and thus also the efficiency of a fuel cell system depend on various system states, as for example temperature or pressure. In order to use as optimal limit values as possible, it may be expedient to adapt the switch-off limit efficiency and/or the switch-on operating load factor to the prevailing system states. To this end an analysis instrument, which by way of sensor data, operating data and state data is able to recognize the relevant system states. Preferably the sensor data, operating data and state data are obtained by so-called polling (cyclic inquiry). However, the use of interrupt requests or recursive structuring is equivalent. The data can then be stored in any data structure, for example an array, list or tree. Advantageously this data structure is generated directly in the particular system used, for example a motor vehicle. The data pool would then become greater, the longer the system operates. This would have the advantage that the stored data stem from this individual system and are correspondingly exact. To this end however it is possible to measure or calculate the data for an exemplary fuel cell system beforehand and store this as ready-made table in the system.

Also, the state of charge of the available energy storage device is observed advantageously. For example the switch-off limit efficiency and/or the switch-on operating load factor can be reduced in the case of a comparatively low battery level.

In an advantageous further embodiment of the inventive method the switch-off limit efficiency and/or the switch-on operating load factor change as a function of a state of the electrical consumer. The two trigger thresholds for the fuel cell can therefore be adapted not only within the fuel cell system, but may be influenced alternatively or in addition to this from outside the fuel cell system. An example for this would be suitable operating conditions of the electrical consumer itself, so that reaction to changes at the electrical consumer can be correspondingly quick in order, additionally to determining the efficiency, to switch the fuel cell on or off at the optimum moment.

In a further very advantageous embodiment of the inventive method the electrical consumer is an electric motor, whereby the switch-off limit efficiency and/or the switch-on operating load factor change as a function of a state of the system operated by the electric motor. Not only the electric motor as electrical consumer itself, but additionally or even alternatively to this, a parameter of the system operated by this electric motor can be used to influence the two trigger thresholds for the fuel cell. Thus, knowledge about the future demands of the fuel cell can be attained very early on and efficiently, for example in the case of a motor vehicle by analyzing a vehicle control unit of such. Thus, in addition to optimizing efficiency, a start/stop system can also be implemented at the same time, which recognizes relatively early on that the fuel cell has entered a range of poor efficiency and can be switched off, for example if the speed of the motor vehicle has dropped to zero, as this is typical with a temporary halt at traffic lights. Likewise very early reaction to starting off can be achieved by correspondingly reducing the switch-on operating load factor, in particular as for example by releasing a brake pedal and/or by pressing an accelerator of the vehicle. The inventive method can therefore be supplemented in an ideal manner by a presently known start/stop system or extended to such.

Preferably the fuel cell is switched off by electrical separation of the fuel cell from the rest of the system. To this end, for example, an actuator in the form of a MOSFET switch with capacitor can be used. Of course the use of any other type of electrical switch is possible.

In a further preferred embodiment when the fuel cell is switched off, the accessory is also switched off. This is also possible using, for example, a MOSFET switch with capacitor or any other electrical switch. It is particularly advantageous if there is a time lapse between switching off the fuel cell and switching off the accessory.

Advantageously the fuel cell is not switched off above a pre-defined system operating load factor. This value can also be either static or change as a function of the system states prevailing in each case.

Preferably if the fuel cell is switched off, the consumer is operated by an energy storage device. To this end the switching device contains an analysis instrument, by which it is possible through sensor data to detect whether the fuel cell is operating or not. The energy storage device can be any device capable of accumulating electricity, in particular a (lead) battery.

In a further advantageous embodiment of the inventive method when the fuel cell is switched off, an air supply to the fuel cell is reduced or switched off. Such an air supply represents a major electrical accessory consumer, so that by switching off or reducing the flow rate, which is generated by this air supply, a substantial effect on energy saving can be achieved. Additionally noise emissions are considerably reduced. Depending on the type of pump system for such an air supply, in this case it may be expedient to completely switch off or only reduce this. In particular when using a dynamic compressor, which during operation runs at very high speeds in the order of more than 50,000 rpm, it is certainly expedient to reduce the speed only in the output in order to likewise reduce noise emissions. Restarting from a speed range of zero however would take a great deal of effort so that a reduction to approx. 10-12,000 rpm appears ideal in order to ensure fast restart of the fuel cell on the one hand and a saving on the other.

Finally the invention relates to the use of the discussed method in a motor vehicle.

### BRIEF DESCRIPTION OF THE DRAWING FIGURES

Some exemplary embodiments of the invention are described below in detail with reference to drawings.

Wherein:

FIG. 1 is a block diagram of a preferred design of a fuel cell system,

FIG. 2 is a chart, which illustrates the efficiency trend of the fuel cell and the efficiency trend of the fuel cell system,

FIG. 3 is a flow chart to illustrate a preferred embodiment of the inventive method, and

FIG. 4 is a general illustration of a vehicle equipped with a fuel cell system.

### DETAILED DESCRIPTION

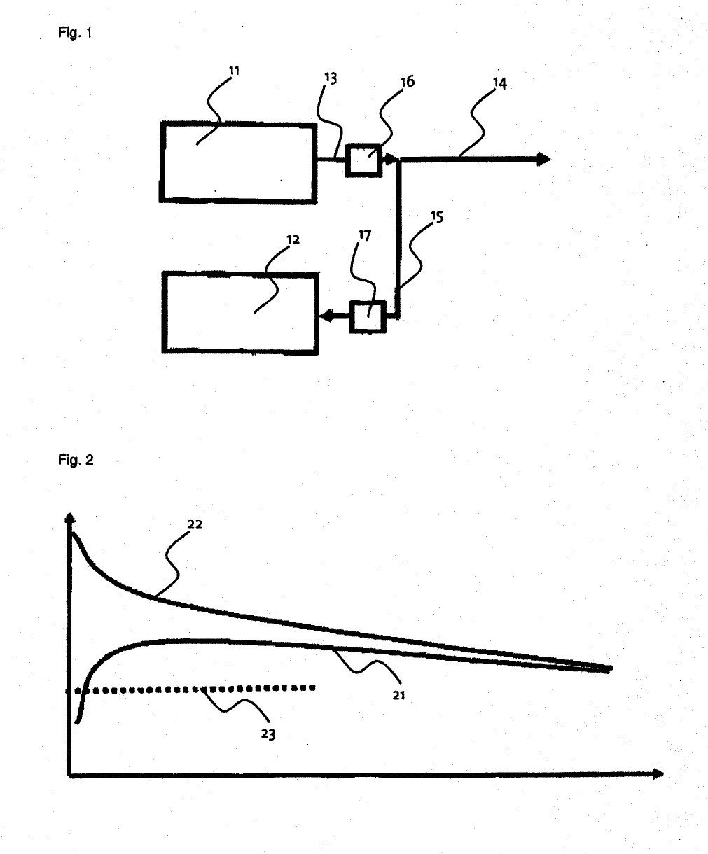

FIG. 1 shows in block diagram form a preferred design of a fuel cell system, whose component parts are a fuel cell (11), an accessory (12), as well as a fuel cell actuator (16) to electrically switch the fuel cell (11) on and off, and an accessory actuator (17) to switch the accessory (12) on and off and thus in particular also to switch the fuel cell (11) on and off. Additionally, the fuel cell current (13), generated by the fuel cell, the net current (14) made available by the fuel cell system and the current (15), consumed by the accessory (12), are schematically illustrated.

All parts of the fuel cell system are electrically connected, for example by wires. The fuel cell actuator (16) is connected between the fuel cell and the other parts of the fuel cell system, so that it can separate the fuel cell (11) from the rest of the system. The accessory actuator (17) is connected between the accessory and the other parts of the fuel cell system, so that it can separate the accessory (12) from the rest of the system. Both the fuel cell actuator (16) and the accessory actuator (17) can be implemented by a MOSFET switch with capacitor or any other electrical switch.

It is evident that the net current (14) represents the difference between the fuel cell current (13), generated by the fuel cell, and the current (15), consumed by the accessory (12).

FIG. 2 is a chart illustrating both the fuel cell efficiency trend (22) as well as the fuel cell system efficiency trend (21). The x axis of the chart in this case represents the current supplied from the fuel cell (11). The y axis of the chart represents the respective efficiency. A switch-off limit efficiency (23) is also illustrated. It is evident that lower the current provided by the fuel cell (11) the fuel cell system efficiency (21) reduces. This is due to the increasing proportion of the energy consumption of the accessories (12). With very low loads it can even be the case that the fuel cell system efficiency (21) falls below 0%.

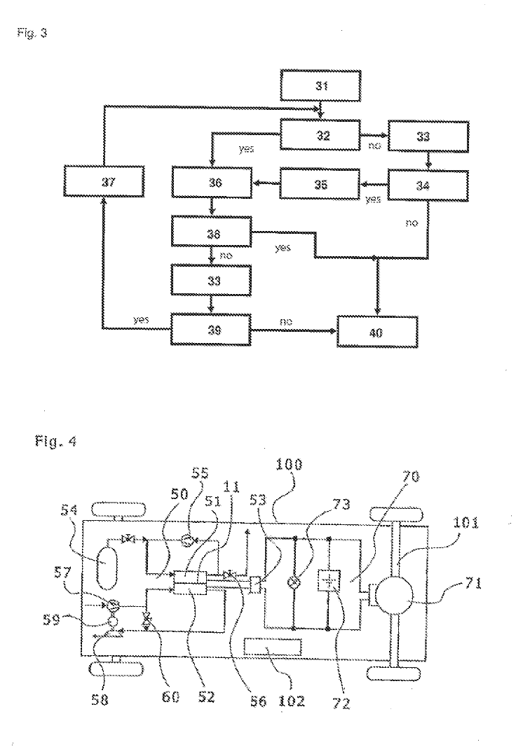

The flow chart according to FIG. 3 shows a preferred embodiment of the method for operating a fuel cell system. This flow chart begins with start (31). A block (32) follows in which it is analyzed whether the fuel cell (11) is switched on. If the fuel cell is switched on, a block (36) follows, in which the efficiency of the fuel cell system is measured. In the following block (38), it is analyzed whether the efficiency of the fuel cell system is higher than the switch-off limiting value. If this is the case, in the following block (33), the operating load is measured. Subsequently, in the following block (39) it is analyzed whether the operating load is less than the system operating load factor. If this is the case, a block (37) follows, in which the fuel cell (11) is switched off. If the analysis in the block (39) has shown that the operating load is greater than the system operating load factor, the end (40) of the process takes place immediately. The same is true if the analysis in the block (38) has shown that the efficiency of the fuel cell system is less than the switch-off limiting value. If the analysis in block (32) shows that the fuel cell (11) is not switched on, a block (33) follows in which the operating load is measured. Subsequently, a block (34) follows, in which it is analyzed whether the operating load is higher than the system operating load factor. If this is the case, a block (35) follows, in which the fuel cell (11) is switched on. Subsequently, the block (36) follows, in which the efficiency of the fuel cell system is measured. Otherwise the end (40) of the process takes place again. This process is used repeatedly.

In the illustration of FIG. 4 now by way of example a vehicle (100), which is to be equipped with a fuel cell system (50), can be seen, indicated in principle. Apart from the fuel cell system (50) the vehicle (100) comprises an electric drive system (70), which rotates a driven axis (101) of the vehicle (100) by means of an electric motor (71). Beside the electric motor (71) the electric drive system (70) also comprises an energy storage device (72), for example a lithium ion battery, as well as possibly further consumers, which are indicated by the consumer (73) shown by way of example. The vehicle (100) is controlled by a vehicle control unit (102) in a manner known per se, so that this is only indicated in principle, without illustrating a cross-linkage with the vehicle (100).

The fuel cell (11) in manner known per se consists of an anode region (51) and a cathode region (52). It is electrically connected via an actuator (53), which also particularly includes the fuel cell actuator (16) and the accessory actuator (17), to the electric drive system (70). Hydrogen is supplied to the anode region (51) of the fuel cell (11) from a hydrogen tank (54), which in particular can be formed as compressed gas tank. The hydrogen flowing out from the anode region (51) of the fuel cell (11) is returned in the circuit via a recirculating pump system (55) to the anode region (51), mixed with fresh hydrogen from the hydrogen tank (54). An outlet valve (56) known per se is also provided in order to drain inert gases and/or water accumulating occasionally in the anode circuit in the manner known per se.

The cathode region (52) is provided with air via an air supply system (57) as oxygen source. The exhaust air from the cathode region (52) is fed directly—or via an additional burner not illustrated here—to a turbine (58) and after this again to the environment. Residual thermal energy and/or pressure energy in the exhaust gas is at least partially recuperated by the turbine (58). The turbine (58) together with the air supply system (57) as well as an optional electric machine (59) can form so-called electric turbochargers (ETC). The electric turbocharger uses the residual energy in the exhaust gases to operate the air supply system (57) and can, if required, also make available drive energy via the electric machine (59) in motor operation. If the energy present in the region of the exhaust gases is so high that the turbine (58) supplies more energy than the air supply system (57) needs, the electric machine (59) can also be driven in a generator operation by the turbine (58), in order additionally to generate current.

The disconnection of the fuel cell (11) in the fuel cell system (50), illustrated here, now functions as already described above. In addition to this the influence is exerted via state variables of the electrical consumer, and in particular the electric motor (71) as well as via variables from the vehicle control unit (102), on the switch-off limit efficiency (23) and the switch-on operating load factor accordingly. This ultimately means that the afore-mentioned functionality in a vehicle application of the fuel cell (11) can be extended by a start/stop system. If the vehicle (100) comes to a temporary halt for example at a red traffic light or due to operating conditions, wherein no drive power is required, for example when driving downhill, this can be detected using state variables of the vehicle control unit (102) and/or the electric motor (71), that is to say wherein it is analyzed whether this is operated with the motor or with the alternator. The disconnection of the fuel cell system can then be accelerated accordingly by increasing the switch-off limit efficiency (23), so that the fuel cell system (50) can be switched very much faster into a stand-by mode. Energy will be saved and noise emissions considerably reduced in this mode. In particular, for this purpose the rotary speed of the air supply system (57) can be considerably reduced. If a described electric turbocharger is used, complete switch-off is often not expedient, since restarting consumes a comparatively great deal of time. Therefore, a reduced rotary speed in the order of 10 to 12,000 rpm in relation to the standard rotary speed of more than 50,000 rpm is preferred. So that it is not necessary for the required residual air to flow through the cathode region (52), an optional system bypass valve (60) can also be provided via which a short-circuit between the input pipe into the cathode region and the output pipe from the same is achieved.

Additionally the hydrogen supply from the hydrogen tank (54) is stopped since no extra hydrogen is required in the fuel cell (11), if this is electrically switched off. However, in order to maintain uniform distribution of the hydrogen within the total anode region (51), the recirculating pump system (55) typically continues to run at reduced speed and circulates the anode exhaust gas in the anode circuit when the exhaust valve (56) is closed and is also mandatorily kept closed in this state. On restarting the system, for example when setting off from the traffic light, the required energy is first made available by the energy storage device (72), until the fuel cell is again switched back to regular operating mode from the stand-by mode. Naturally the efficiency supervision of the fuel cell continues to override all this, so that the fuel cell (11) is not switched on whenever this does not appear expedient on account of the efficiency.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SYMBOL LIST

11 Fuel cell

12 Accessory

13 Fuel cell current

14 Net current

15 Current consumed by the accessory

16 Fuel cell actuator

17 Accessory actuator

21 Fuel cell system efficiency trend

22 Fuel cell efficiency trend

23 Switch-off limit efficiency

31 Start

32 Analysis of the fuel cell

33 Measurement of the operating load

34 Analysis of the operating load

35 Switch-on of the fuel cell

36 Measurement of the system efficiency

37 Switch-off of the fuel cell

38 Analysis of the system efficiency

39 Analysis of the operating load

40 End

50 Fuel cell system

51 Anode region

52 Cathode region

53 Actuator

54 Hydrogen tank

55 Recirculating pump system

56 Outlet valve

57 Air supply system

58 Turbine

59 Electric machine

60 System bypass valve

70 Electric drive system

71 Electric motor

72 Energy storage device

73 Further electrical consumers

100 Vehicle

101 Driven axis

102 Vehicle control unit

1-14. (canceled)

15. A method for operating a fuel cell system, comprising:
supplying at least one electrical consumer with electrical energy, wherein the fuel cell system includes at least one fuel cell and at least one accessory for supplying the fuel cell;
determining an efficiency of the fuel cell system; and
temporarily switching off the fuel cell when the determined efficiency of the fuel cell system falls below a switch-off limit efficiency,
wherein the fuel cell system comprises a recirculation of anode exhaust gases around an anode of the fuel cell with an anode recirculating pump system, and wherein when the fuel cell is switched off, the flow rate demanded by the anode recirculating pump system is maintained or reduced but not switched off.

16. The method according to claim 15, further comprising:
restarting the fuel cell when a switch-on operating load factor is exceeded.

17. The method according to claim 16, wherein the switch-off limit efficiency or the switch-on operating load factor changes as a function of system states.

18. The method according to claim 16, wherein the switch-off limit efficiency or the switch-on operating load factor changes as a function of a state of the electrical consumer.

19. The method according to claim 16, wherein the electrical consumer is an electric motor, wherein the switch-off limit efficiency or the switch-on operating load factor change as a function of a state of the fuel cell system, operated by the electric motor.

20. The method according to claim 15, wherein the fuel cell is switched off by electrical separation of the fuel cell from the rest of the fuel cell system.

21. The method according to claim 15, wherein the accessory is switched off when the fuel cell is switched off.

22. The method according to claim 21, wherein there is a time lapse between switching off the fuel cell and switching off the accessory.

23. The method according to claim 15, wherein an air supply to the fuel cell is reduced or switched off when the fuel cell is switched off.

24. The method according to claim 15, wherein the fuel cell is not switched off above a system operating load factor.

25. The method according to claim 15, wherein the consumer is operated by an energy storage device when the fuel cell is switched off.

26. The method of claim 15, wherein the fuel cell system is part of a motor vehicle.
